(19) United States
(12) Patent Application Publication
(10) Pub. No.: US 2009/0047639 A1
(43) Pub. Date: Feb. 19, 2009

(54) UNIVERSAL AIDS FOR TEXT BASED LEARNING

(76) Inventor: Zvi Kamenetzky, Toronto (CA)

Correspondence Address: JOHN PETRAVICH;INTEGRATED DNA TECHNOLOGIES, INC., 8180 MCCORMICK BLVD., SKOKIE, IL, 60076-2920, US

(21) Appl. No.: 12/192,334

(22) Filed: Aug. 15, 2008

Related U.S. Application Data
(60) Provisional application No. 60/956,632, filed on Aug. 17, 2007.

(51) Int. Cl. G09B 19/06

(52) U.S. Cl. 434/157

(57) ABSTRACT

The invention provides study aids that work in tandem with a preferred format of ancient or foreign texts. In one embodiment, the invention provides an overlay containing a partial or full set of the vowel and punctuation marks. The overlay can be transparent or otherwise fashioned to superimpose the text without being permanently affixed with the text itself. A beginning student can rely on a more comprehensive overlay containing nearly all of the vowel or punctuation markings, and the overlays can be modified to provide levels of assistance to match the skills of the student or the comfort of the parent or instructor.

### FIELD OF THE INVENTION

This invention pertains to materials to enhance the learning of written material. In one embodiment, the invention is applied to the study of foreign or ancient texts in compliance with cultural or religious norms.

### BACKGROUND OF THE INVENTION

The Torah is the biblical text forming the foundation of Judaism. The Torah contains five books, and it is also more generally referred to as the “Five Books of Moses” because, according to the faith, they were revealed directly to Moses from God. According to the Judaic faith, the Torah was initially written in Hebrew without vowel or punctuation markings, but the vowels were orally communicated from God to Moses, ensuring that Moses would be able to orally transmit to others the information required to understand the Torah.

Additionally according to the faith, an entire set of laws and traditions which are derived from the five written books was orally transmitted by God to Moses. This has been traditionally referred to as the oral law. This part of the Torah evolved through generations of intense study and specific methods of derivation according to the needs of the evolving society. The conclusions of these discussions were transmitted orally until the conclusion of the Babylonian exile wherein these teachings were sealed (i.e., finalized, not added to or further amended) and titled the Babylonian and Jerusalem Talmud. Thereafter, each generation added numerous commentaries to the Talmud. These Talmudic teachings, including commentaries, were permitted to be written with limited vowelization and punctuation to provide limited assistance and thereby ensuring the preservation of the oral communication traditions.

The tradition of transmitting ancient Middle Eastern texts has continued in the Judaic faith, and it has extended to the other texts such as the rabbinical commentaries on the Torah known as the Talmud. The Talmud is written in Aramaic also without vowels. The missing information requires the interaction of teachers and students or parents and children and preserves the tradition and culture from generation to generation. The interaction in turn builds an appreciation for prior generations and their contributions to the faith.

There are study aids that provide the vowels and punctuation marks in order to reduce the time and effort required to learn the Talmud in Aramaic, but the aids in turn reduce the emphasis, or run contrary, to the oral teachings that are considered essential to many in the faith. Some consider the text tarnished or seriously compromised when it contains the vowel and punctuation markings directly with the text itself. However, the resources required for training students to read a text unmarked with the vowels and punctuations are limited, and therefore instructors and parents are compelled to make the choice between no teaching of the text or a compromised teaching of the text.

There is therefore a need to provide teaching aids that do not compromise the foundational text but still provide the level of utility required for efficient memorization and comprehension. The invention provides study aids that assist the instruction of foreign and ancient texts without compromising the integrity of the texts themselves.

### BRIEF SUMMARY OF THE INVENTION

The invention comprises study aids that work in tandem with a text material, wherein the text material remains pristine or unmarked. In one embodiment, the study aid comprises an overlay material that is distinct from the text material. In a further embodiment, the text material is comprised of ancient or foreign texts. In a further embodiment, the invention comprises an overlay containing a partial or full set of the vowel and punctuation marks. The overlay can be transparent or otherwise fashioned to superimpose the text without being permanently affixed with the text itself. A beginning student can rely on a more comprehensive overlay containing nearly all of the vowel or punctuation markings, and the overlays can be modified to provide layers of overlays providing levels of assistance to match the skills of the student or the comfort of the parent or instructor.

### BRIEF DESCRIPTION OF THE DRAWINGS

FIG. 1 illustrates the original appearance of the Talmud, center, and commentaries surrounding the Talmudic text, both in Aramaic.

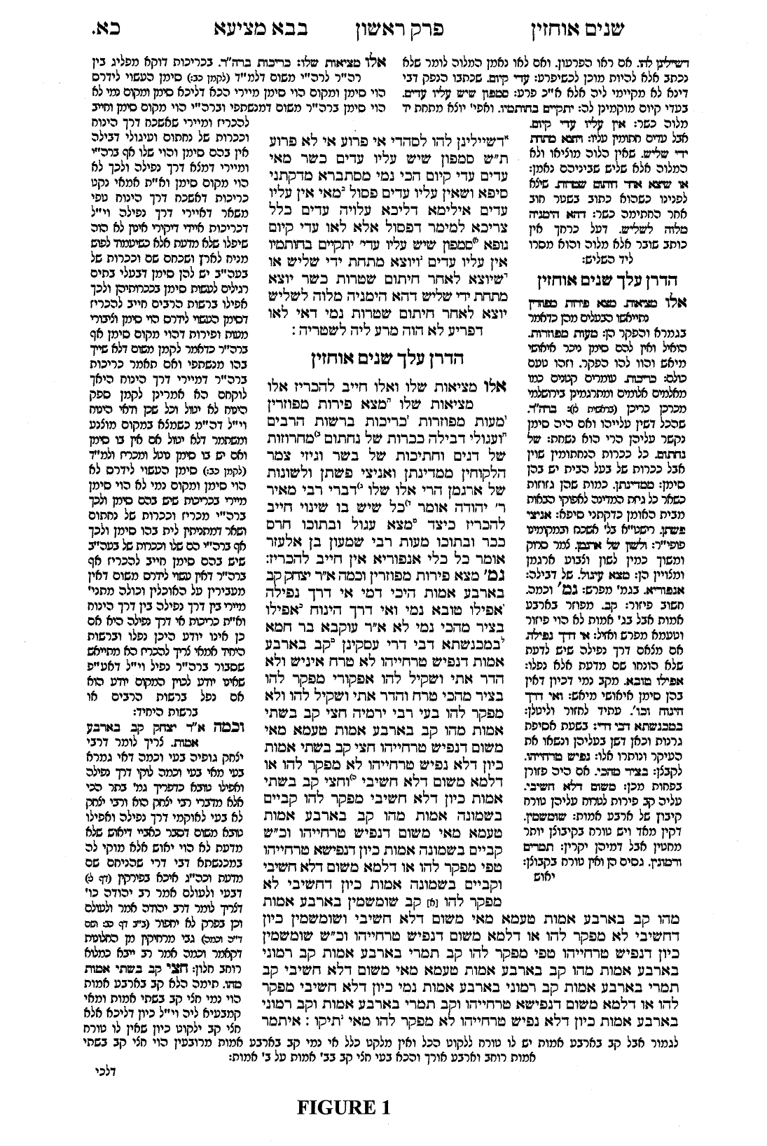

FIG. 2 illustrates the appearance of the Talmud in FIG. 1 containing vowel markings.

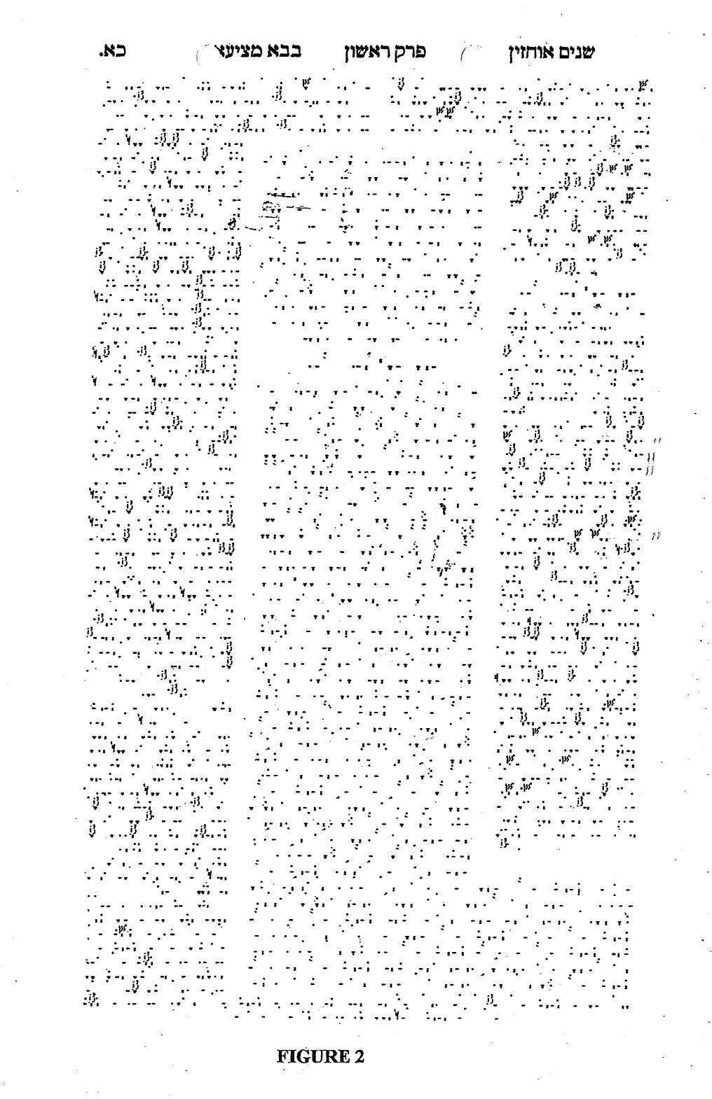

FIG. 3 illustrates the unmarked Aramaic text from FIG. 1 with an overlay that provides a set of vowel markings from FIG. 2.

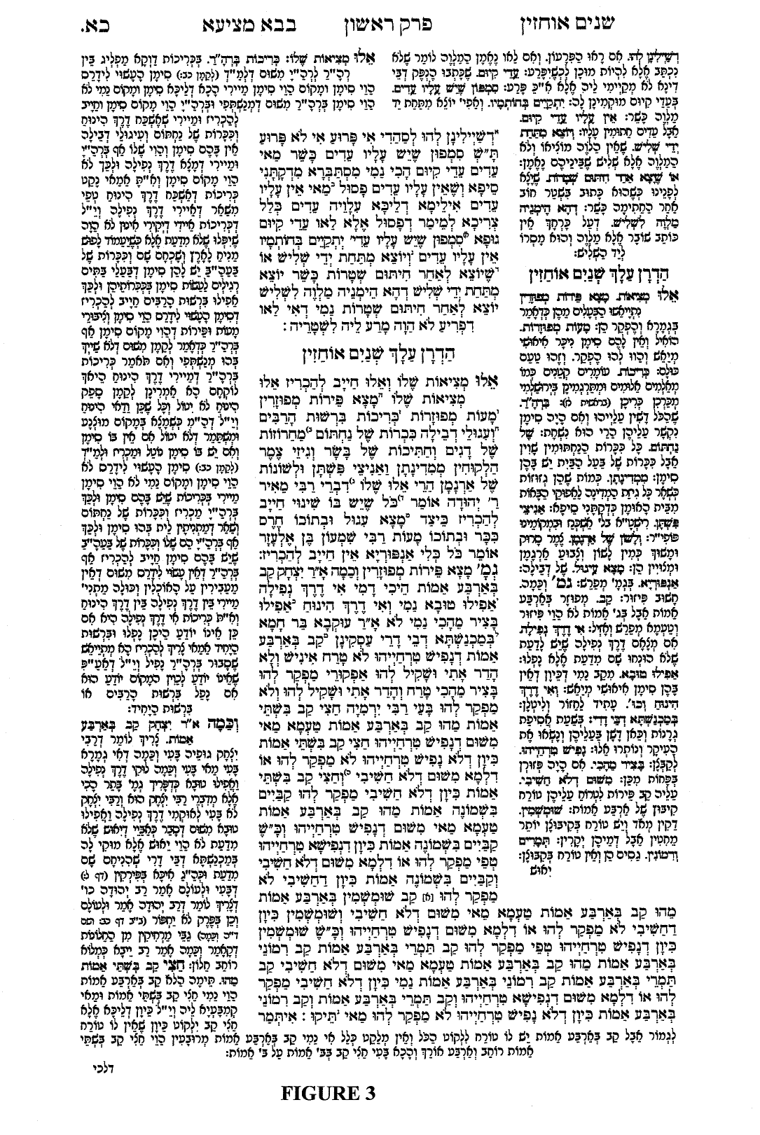

### DETAILED DESCRIPTION OF THE INVENTION

The invention comprises study aids that work in tandem with any textual material, wherein the text material remains pristine or unmarked. In one example, a text book that a user desires to remain unmarked (e.g., the text book would be reused) would contain disposable or erasable overlays. This allows the user to keep any notation in proximity with corresponding text. Classroom discussion of the text would no longer require extensive summarization of textual content independent of the text. Rather the additional notes and commentary would be integrated via the invention within the actual text as footnotes, sidebars and commentary. In one embodiment, the study aid comprises an overlay material that is distinct from the text material. The invention also provides a study aid that works in tandem with ancient or foreign texts. In one embodiment, the invention provides an overlay containing a partial or full set of the vowel and punctuation marks. The overlay can be transparent or otherwise fashioned to superimpose the text without being permanently affixed with the text itself. A beginning student can rely on a more comprehensive overlay containing nearly all of the vowel or punctuation markings, and the overlays can be modified to provide levels of assistance to match the skills of the student or the comfort of the parent or instructor.

The overlay can be broadly defined to include not only transparencies, but any device that allows the student to view the unmarked text along with the corresponding markings. This can include a modified, incomplete page wherein the incomplete page has areas missing that allow for any underlying text to be viewed simultaneously with the markings, or vice versa.

In another embodiment, the study aids could be in software or another form otherwise viewable in a medium that is not exclusively printed text. This embodiment could include software that teaches the same concepts while still providing a format that separates the unmarked text from the markings.

The term “text” includes not only alphanumeric symbols, but also graphs, drawings, figures, pictures and anything that can be depicted in two-dimensional form.

In another embodiment, the study aids provide a system wherein the student is given the full text or a portion of the unmarked text and is able to verify his reading of the text, or seek assistance for the reading of the text by viewing only the portion of the markings as the student requires for verification of the reading.

In another embodiment, the study aid can be comprised of a mix of a complete or incomplete set of vowel and punctuation markings combined with a complete or incomplete set of consonants or other text. In another embodiment, the study aids can provide multiple choices for vowel or punctuation markings wherein the student can choose the correct markings.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A study aid for improving the study of a text, the study aid comprising:
a) a first portion of text; and
b) an overlay wherein the overlay provides a medium to provide a second portion of text that supplements the first portion.

2. The study aid of claim 1 wherein the text is a foreign or ancient text.

3. The study aid of claim 1 wherein the first portion is comprised of consonants and the second portion is comprised of vowels and punctuation.

4. The study aid of claim 1 wherein the overlay is comprised of a transparent material that allows for the second portion of text to be align with the first portion of text to provide a more complete portion of text, and wherein both the first portion and second portion can be viewed simultaneously.

5. The study aid of claim 1 wherein the overlay is comprised of a material that contains one or more openings, wherein when the overlay is on top of the first portion the first portion can be at least partially viewed through the openings in the overlay.

6. The study aid of claim 1 wherein a second overlay is provided to provide a third portion of text, wherein the third portion of text optionally contains a part of the second portion of text.

7. A method of memorizing foreign or ancient texts, said method comprising:
a) providing a first portion of a text that is subject to memorization; and
b) providing a second portion of a text wherein a person learning the text can combine the second portion of the text to provide a more comprehensive text.

8. A study aid for improving the study of a foreign or ancient text, the study aid comprising a medium containing at least a partial set of punctuation markings corresponding to a foreign or ancient text that can be combined or overlaid onto the foreign or ancient text that does not contain some or all of the medium punctuation markings.
